(19) United States
(12) Patent Application Publication
(10) Pub. No.: US 2003/0022561 A1
(43) Pub. Date: Jan. 30, 2003

(54) Auxiliary fixing device of plate type connector

(76) Inventors: Master Peng, Taipei (TW); Kevin Yeh, Taipei (TW)

Correspondence Address: Master Peng, 235 Chung-Ho, Box 8-24, Taipei, TW

(21) Appl. No.: 10/046,038

(22) Filed: Jan. 15, 2002

(30) Foreign Application Priority Data
Jul. 27, 2001 (TW) 090212843

(51) Int. Cl. H01R 13/40

(52) U.S. Cl. 439/733.1

(57) ABSTRACT

An auxiliary fixing device of a plate type connector is disclosed. When the plate type connector are welded to a circuit board from different directions, it is unnecessary to change the auxiliary pins; a selected one of two mounting portions is used to be stuck to the circuit board. The shapes of the auxiliary pins are redesigned so that two mounting portions are arranged at two adjacent sides of the auxiliary pins. When the auxiliary pins are inserted into the engaging grooves at two sides of the plate type connector. The mounting portions exposes from the plate type connector. Therefore, as the plate type connector is welded to a circuit board for different directions, it is unnecessary to change the auxiliary pins; and a selected one of two mounting portions is used to be stuck to the circuit board.

### FIELD OF THE INVENTION

The present invention relates to connectors, and particularly to a plate type connector. When the plate type connector are welded to a circuit board from different directions, it is unnecessary to change the auxiliary pins, and a selected one of two mounting portions is used to be stuck to the circuit board.

### BACKGROUND OF THE INVENTION

FIG. 1 shows the structure of a prior plate type connector. The plate type connector includes a body 10, a plurality of metal terminals 11 which are used as electric joints, and auxiliary pins 12 welded at two sides of the plate type connector adjacent to the sides having the metal terminals. When the metal terminals 11 of the plate type connector are welded to a circuit board 13 (referring to FIGS. 2A and 2B), by the connection of auxiliary pins 12 and the circuit board 13, an auxiliary sticky force is provided. Thereby, the connection of the plate type connector and the circuit board are steadier.

In general, there are two directions for mounting a plate type connector to a circuit board (referring to FIGS. 2A and 2B). The auxiliary pins 12 may be mounted to the body 10 from the inserting slots 14a or 14b as required. As a result, before deciding the connection way of the plate type connector and the circuit board 13, the auxiliary pins 12 are not assembled to the body 10 of the plate type connector mounted with metal terminals 11. Therefore, the auxiliary pins 12 and the body 10 are stored separately. However, this way induces that the user must store many stokes and some further assembly work is necessary as a plate type connector is mounted to a circuit board.

### SUMMARY OF THE INVENTION

Accordingly, the primary object of the present invention is to provide an auxiliary fixing device of a plate type connector, wherein when the plate type connector are welded to a circuit board from different directions, it is unnecessary to change the auxiliary pins; a selected one of two mounting portions is used to be stuck to the circuit board.

To achieve above objects, the present invention provides an auxiliary fixing device of a plate type connector. In the present invention, the shapes of the auxiliary pins are redesigned so that two mounting portions are arranged at two adjacent sides of the auxiliary pin. When the auxiliary pins are inserted into the engaging grooves at two sides of the plate type connector. The mounting portions exposes from the plate type connector. Therefore, as the plate type connector is welded to a circuit board form different directions, it is unnecessary to change the auxiliary pins; a selected one of two mounting portions is used to be stuck to the circuit board so as to provide an auxiliary force.

The various objects and advantages of the present invention will be more readily understood from the following detailed description when read in conjunction with the appended drawing.

### BRIEF DESCRIPTION OF THE DRAWINGS

FIG. 1 shows the structure of a prior plate type connector and the auxiliary pins thereof.

FIGS. 2A and 2B shows the structure of the auxiliary pins and circuit board as a prior plate type connector is mounted from different directions.

FIG. 3 shows the structure of a plate type connector and the auxiliary pins of the present invention.

FIGS. 4A and 4B shows the structure of the auxiliary pins and circuit board as the plate type connector of the present invention is mounted from different direction.

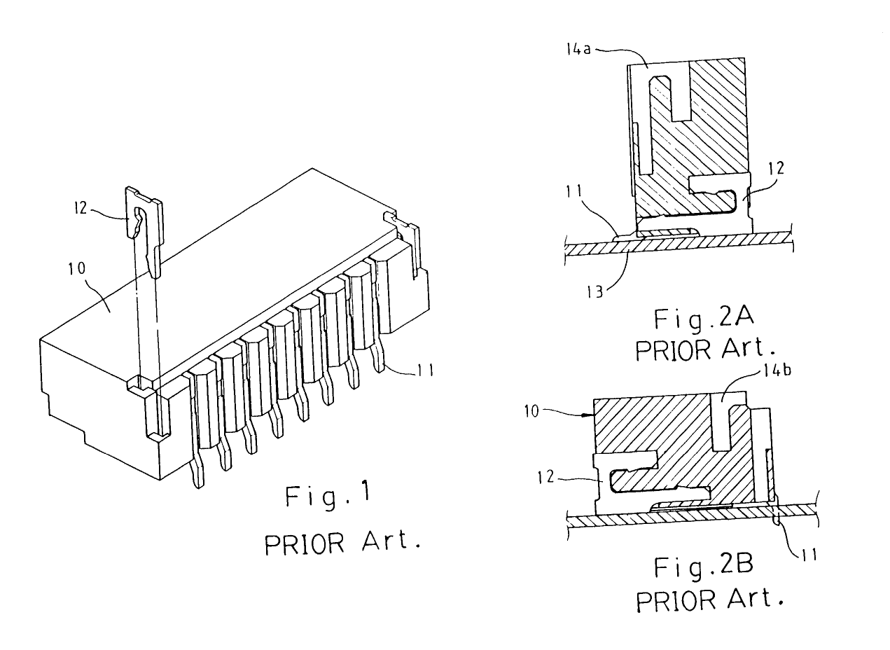

### DETAILED DESCRIPTION OF THE PREFERRED EMBODIMENTS

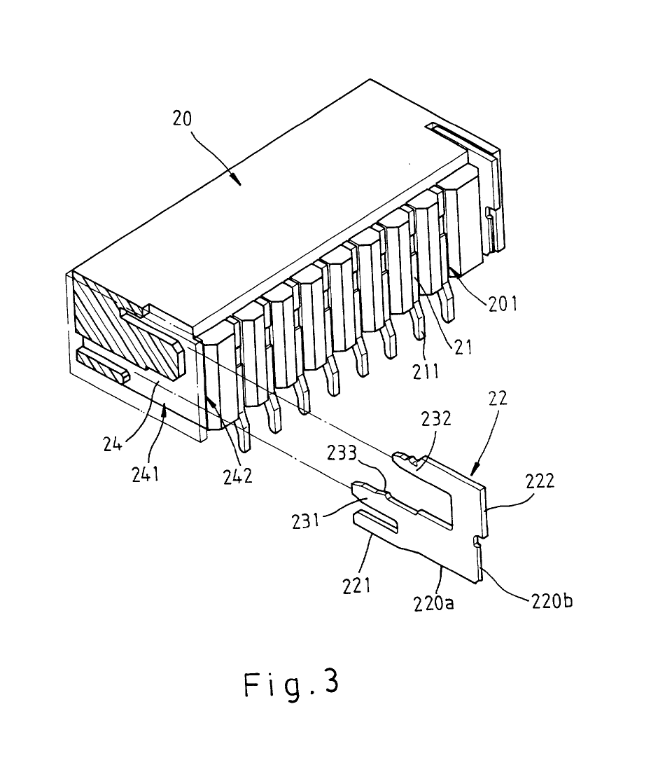

Referring to FIGS. 3, the plate type connector of the present invention includes the following components.

An insulating body 20 is an approximately rectangular shape. A plurality of terminal grooves 201 are arranged in one of the long lateral sides and are spaced with one another.

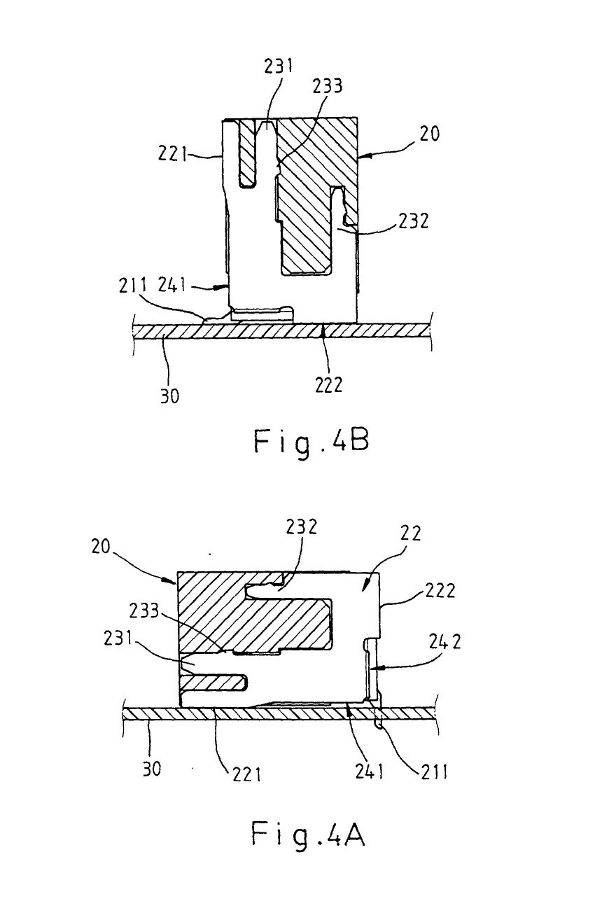

A plurality of metal terminals 21 are inserted into the terminal grooves 201, respectively. One end of the metal terminal 21 is extended with a welding end 211 for being welded to a printed circuit board (not shown) of a circuit board 30. When the plate type connector is installed, for example, transversally to the circuit board 30 (referring to FIG. 4A), the welding ends 211 are inserted into the circuit board 30. Referring to FIG. 4B, when the plate type connector is installed longitudinally to the circuit board 30, the welding end 211 is installed to the circuit board 30 by surface mounting technology. In these two orientations, the welding way for welding the welding end 211 to the circuit board 30 may be changed by modifying the structure of the welding end 211 as desired.

A pair of the auxiliary pins 22 are installed to two sides of the insulating body 20 adjacent to the side having terminal grooves 201. The auxiliary pins 22 are inserted into the insulating body 20 along a direction parallel to the metal terminal 21. The auxiliary pin 22 has a first mounting portion 221 and a second mounting portion 222 for connecting the auxiliary pin 22 to the circuit board 30. The first mounting portion 221 and the second mounting portion 222 are arranged at two adjacent sides 220a and 220b of the auxiliary pin 22. Each auxiliary pin 22 has a plurality of engaging pieces 231 and 232, thereby, the auxiliary pin 22 being engaged with the insulating body 20. By the elasticity of the engaging pieces 231 and 232 and a hook 233 protruded from the edges, the auxiliary pin 22 can be fixed to the insulating body 20.

Two engaging grooves 24 at two sides of the insulating body 20. The engaging grooves 24 and the sides of the insulating body 20 adjacent to the engaging grooves 24 have notches 241, 242, respectively. When the auxiliary pins 22 are inserted into the engaging grooves 24, the first mounting portion 221 and second mounting portion 222 may expose out from the notches 241, 242

Therefore, when the plate type connector is welded to the circuit board 30 from different orientation, it can be stuck to the circuit board 30 by the first mounting portion 221 or second mounting portion 222 without remounting the auxiliary pins 22. Thereby, a strong sticky force is provided. For example, when the insulating body 20 of the plate type connector is transversally installed to the circuit board 30 (referring to FIG. 4A), the first mounting portion 221 can be used to be stuck to the surface of the circuit board 30 (referring to FIG. 4A). When the insulating body 20 of the plate type connector is vertically installed to the circuit board 30 (referring to FIG. 4B), the second mounting portion 222 is used to be stuck to the surface of the circuit board 30.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An auxiliary fixing device of a plate type connector comprising an insulating body, a plurality of metal terminals, and two auxiliary pins; wherein the metal terminals of the plate type connector are welded to a circuit board, the auxiliary pins are stuck to the circuit board so as to provide an auxiliary sticky force to the plate type connector, characterized in that:
the auxiliary pins have two mounting portions for being stuck to the circuit board; the two mounting portions are positioned at two sides of the auxiliary pins, respectively; each of two sides of the insulating body is formed with an engaging groove for being engaged with one of the auxiliary pins; a notch is formed between each of the engaging groove and a side of the insulating body adjacent to the engaging groove; thereby, as the auxiliary pins are engaged with the engaging grooves, the two mounting portions are exposed out from the notches;
wherein when the insulating body are welded to the circuit board from different directions, it is unnecessary to change the auxiliary pins; a selected one of the mounting portions is used to be stuck to the circuit board so as to provide an auxiliary force.

2. The auxiliary fixing device of a plate type connector as claimed in claim 1, wherein each of the auxiliary pins has a plurality of engaging pieces for being engaged to the insulating body; each engaging piece is elastic and has a hook protruded from one edge; thereby, the auxiliary pins are fixed to the engaging grooves of the insulating body by the engaging pieces.
